(19) United States
(12) Patent Application Publication
(10) Pub. No.: US 2013/0208302 A1
(43) Pub. Date: Aug. 15, 2013

(54) RELAY SERVER APPARATUS

(71) Applicants: Shun TANAKA, West New York, NJ (US); Yuki Uchida, Lincoln Park, NJ (US)

(72) Inventors: Shun TANAKA, West New York, NJ (US); Yuki Uchida, Lincoln Park, NJ (US)

(73) Assignee: RICOH COMPANY, LTD., Tokyo (JP)

(21) Appl. No.: 13/370,455

(22) Filed: Feb. 10, 2012

(51) Int. Cl. G06F 3/12

(52) U.S. Cl. 358/1.15

(57) ABSTRACT

Information technology tools are provided to allow a user at any of plural heterogeneous multi-function devices of different vendors to access the functionalities of any of plural heterogeneous server devices of different vendors.

### TECHNICAL FIELD

This disclosure relates to tools (systems, apparatuses, methodologies, computer program products, etc.) for accessing the functionalities of plural heterogeneous multi-function devices and plural heterogeneous server devices provided by different vendors.

### BACKGROUND

In the current information age, various information technology (IT) tools are extensively used by enterprises and other organizations, in order to provide convenient processing and storage of various documents and data. For example, multi-function devices (MFDs) allow users to perform numerous processing functions with respect to documents and data, such as a scan operation to scan a hardcopy document in order to generate an electronic image of the document, an optical character recognition operation to extract text from the electronic image, a print operation to print out a hardcopy version of an electronic document, etc.

While some functions can be natively provided on the MFD, other functions may be obtained from, or are facilitated by, a server which may provide various support services and functionalities for the operation of the MFD. For example, when the MFD performs a scan operation, the scan image data from the MFD may be transmitted to a server and stored in a document store or other storage device managed by the server (often referred to as “scan-to-store”). As another example, an MFD may allow a user at the MFD to select a document or file stored remotely server-side and request that the selected document or file be printed.

Currently, many enterprises and other organizations do not rely on a single, unified document input/output platform and instead employ heterogeneous MFDs that are provided by different vendors, along with a large number of heterogeneous server devices provided by different vendors for the different multi-function devices. FIG. 1 illustrates such a conventional system 100 wherein an MFD A 18 provided by Vendor A includes a Server A client 18-1, and MFD A 18 is connected via a network connection 11-1 to Server A that is also provided by Vendor A. The system 100 of FIG. 1 also includes an MFD B 19 provided by Vendor B that includes a Server B client 19-1, and MFD B 19 is connected via a network connection 11-2 to Server B that is also provided by Vendor B.

However, each vendor typically has an established set of software, communication protocols and data formats. That is, MFD A and server A communicate with each other using a first communication format established by vendor A, while MFD B and server B communicate with each other using a second communication format established by vendor B. Accordingly, a user of MFD A is able to access the functionalities offered by server A (such as being able to access documents, data and software stored on server A), but is not able to access the functionalities offered by server B, since MFD A and server B use different communication formats and are unable to fully communicate with each other. Similarly, a user of MFD B can access the functionalities offered by server B (such as accessing documents, data, software on server B), but is not able to access functionalities offered by server A, since MFD B and server A use different communication formats and are unable to properly communicate with each other.

Each MFD (e.g., MFD A and MFD B in FIG. 1) conventionally includes a user interface to allow the user to access the functionalities of that MFD. However, the user interface of MFD A typically has a different presentation format, layout and style, etc., as compared to the user interface of MFD B. Thus, users of both MFD A and MFD B are forced to learn, and adapt to, the different user interfaces of the different MFDs.

There exists a need for an improved system for accessing the functionalities of plural heterogeneous multi-function devices and plural heterogeneous server devices provided by different vendors.

### SUMMARY

In an aspect of this disclosure, there is provided a tool (for example, a relay apparatus, application software, etc.) for accessing the functionalities of plural heterogeneous multi-function devices and plural heterogeneous server devices provided by different vendors. In an exemplary embodiment, a relay tool includes a server connector part configured for communication with plural heterogeneous server devices provided by respective different vendors, a device connector part configured for communication with plural heterogeneous multi-function devices (MFDs) provided by different vendors, and a common user interface part to receive user instructions utilizing a common user interface that permits the user of any of the plural MFDs to access the functionalities of any of the plural server devices.

In another aspect, the common user interface of the relay apparatus may be utilized by the user to operate each and all of the plural MFDs, as if the user were actually operating each specific MFD via the native user interface screen of the specific MFD. Thus, such common user interface acts as a unified interface that can replace the need for the user to operate the different user interface screens of plural MFDs.

In another aspect, the common user interface part receives user selection of a specific one of the plural multi-function devices and a user instruction to access functionalities of the selected multi-function device, a processing part converts the user instruction received through the common user interface part into a format native to the selected multi-function device, and a device connector part connectable to the plural multi-function devices transmits the converted instruction to the selected multi-function device in the format native to the selected multi-function device, to access the functionalities of the selected multi-function device.

In another aspect, the processing part selects, based on the user instruction, a specific server device from among the plural server devices, and converts (i) the data received by the device connector part in the format native to the selected multi-function device and (ii) the user instruction, into a format native to the specific server device, and the server connector part transmits the converted data and instruction to (and receives data from) the specific server device in the format native to the specific server device, to access the functionalities of the specific server device based on the user instruction.

In another aspect, in a case that the user instruction corresponds to a scan operation instruction, the processing part converts the scan operation instruction into the format native to the selected multi-function device, the device connector part transmits the converted scan operation instruction to the selected multi-function device to cause the selected multi-function device to perform the scan operation, and receives scan image data from the selected multi-function device in the format native to the selected multi-function device. Further, the processing part converts (i) the scan image data received by the device connector part in the format native to the selected multi-function device and (ii) the user instruction, into a format native to the specific server device, and the server connector part transmits the converted scan image data and the converted user instruction to the specific server device in the format native to the specific server device, to access the functionalities of the specific server device based on the user instruction.

In another aspect, a scan operation instruction includes an instruction to store the scan image data in a particular storage unit connected to the specific server device, and the server connector part transmits the converted scan image data and scan operation instruction to the specific server device in the format native to the specific server device, to cause the specific server device store the scan image data in the particular storage unit.

In another aspect, the scan operation instruction includes an instruction to email the scan image data to a particular email address, and the server connector part transmits the converted scan image data and scan operation instruction to the specific server device in the format native to the specific server device, to cause the specific server device to email the scan image data to the particular email address.

In another aspect, in a case that the user instruction corresponds to a print operation instruction, the processing part converts the print operation instruction into the format native to the selected multi-function device, the device connector part transmits the converted print operation instruction to the selected multi-function device to cause the selected multi-function device to process the print operation instruction, and receives a data request from the selected multi-function device in the format native to the selected multi-function device. Further, the processing part converts (i) the data request received by the device connector part in the format native to the selected multi-function device and (ii) the user instruction, into the format native to the specific server device, and the server connector part transmits the data request and the converted user instruction to the specific server device in said format native to the specific server device, and receives document data from the specific server device based on the user instruction. The processing part converts the document data into print data in the format native to the selected multi-function device, and the device connector part transmits the print data to the selected multi-function device to cause the selected multi-function device to perform the print operation.

In another aspect, in a case that the user instruction corresponds to a print operation instruction, the processing part generates a print data request in the format native to the specific server device, based on the print operation instruction, the server connector part transmits the print data request to the specific server device and receives document data from the specific server device, the processing part converts the document data into print data in the format native to the selected multi-function device, and converts the print operation instruction into the format native to the selected multi-function device, and the device connector part transmits the converted print data and print operation instruction to the selected multi-function device, to cause the selected multi-function device to perform the print operation.

In another aspect, the relay tool further comprises an authentication part to authenticate the user of the relay apparatus. The processing part only converts the user instruction into the format native to the selected multi-function device, and the device connector part only transmits the converted instruction to the selected multi-function device, if the user authentication part determines that the user is authenticated to access the functionalities of the selected multi-function device.

In another aspect, the processing part only converts data into the format native to a server device, and the server connector part only transmits data to the server device, if the user authentication part determines that the user is authenticated to access the functionalities of the server device.

### BRIEF DESCRIPTION OF THE DRAWINGS

The aforementioned and other aspects, features and advantages can be more readily understood from the following detailed description with reference to the accompanying drawings wherein:

FIG. 1 shows a block diagram of a conventional system including plural multi-function devices and plural server devices;

FIG. 2 shows a block diagram of a system including plural multi-function devices, plural server devices, and a relay apparatus, according to an exemplary embodiment;

FIG. 3 illustrates an example of a user interface screen displayed on a relay apparatus, such as relay apparatus 20 depicted in FIG. 2, that allows a user to select a print device;

FIG. 4A illustrates an example of a conventional user interface screen displayed on multi-function device, such as MFD A depicted in FIG. 2;

FIG. 4B illustrates an example of a conventional user interface screen displayed on multi-function device, such as MFD B depicted in FIG. 2;

FIG. 5 illustrates an example of a user interface screen displayed on a relay apparatus, such as relay apparatus 20 depicted in FIG. 2, according to an exemplary embodiment;

FIG. 6 illustrates an example of a file browse page displayed on a relay apparatus, such as relay apparatus 20 depicted in FIG. 2, according to an exemplary embodiment;

FIG. 7 shows a flowchart of a method performed by a relay apparatus, such as relay apparatus 20 depicted in FIG. 2, according to an exemplary embodiment;

FIG. 8 shows a block diagram of an exemplary configuration of a computer that can be used to implement a relay apparatus, such as relay apparatus 20 illustrated in FIG. 1;

FIG. 9 shows a block diagram of an exemplary configuration of a multi-function device, such as MFD A and/or MFD B illustrated in FIG. 2;

FIG. 10 shows a more detailed flowchart of a more detailed method performed by a relay apparatus, such as relay apparatus 20 depicted in FIG. 2, according to an exemplary embodiment;

FIG. 11 illustrates a schematic diagram demonstrating a data flow in a system, such as system 200 illustrated in FIG. 2, according to an exemplary embodiment;

FIGS. 12A and 12B shows a more detailed flowchart of a more detailed method performed by a relay apparatus, such as relay apparatus 20 depicted in FIG. 2, according to an exemplary embodiment;

FIG. 13 illustrates a schematic diagram demonstrating a data flow in a system, such as system 200 illustrated in FIG. 2, according to an exemplary embodiment;

FIGS. 14A and 14B shows a more detailed flowchart of a more detailed method performed by a relay apparatus, such as relay apparatus 20 depicted in FIG. 2, according to an exemplary embodiment;

FIG. 15 illustrates a schematic diagram demonstrating a data flow in a system, such as system 200 illustrated in FIG. 2, according to an exemplary embodiment;

FIG. 16 shows a block diagram of a system including plural multi-function devices, plural server devices, and a relay apparatus, according to another exemplary embodiment; and

FIGS. 17A and 17B illustrate examples of user interface screens displayed on a relay apparatus, such as relay apparatus 20-1 illustrated in FIG. 16, that allow a user to enter a user name and password for authentication.

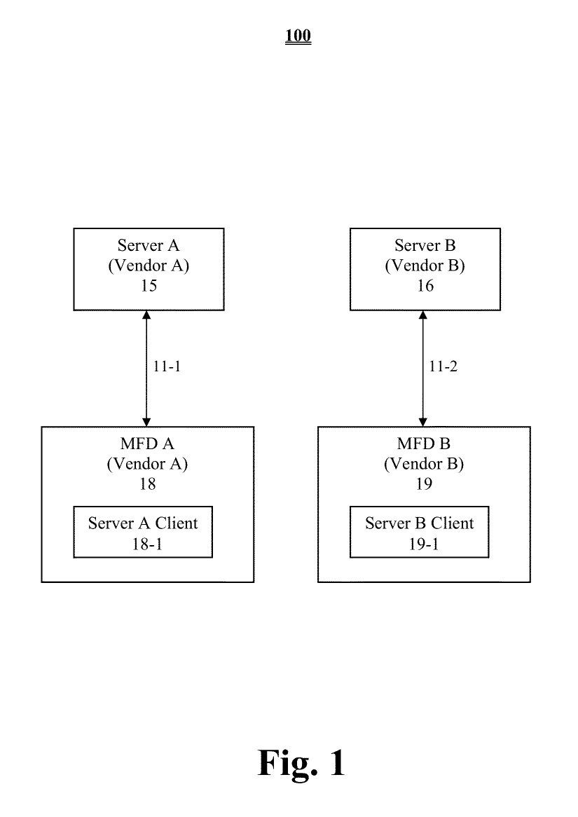

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. In addition, a detailed description of known functions and configurations will be omitted when it may obscure the subject matter of the present invention.

Referring now to the drawings, wherein like reference numerals designate identical or corresponding parts throughout the several views, there is described tools (systems, apparatuses, methodologies, computer program products, etc.) for accessing the functionalities of plural heterogeneous multi-function devices and plural heterogeneous server devices.

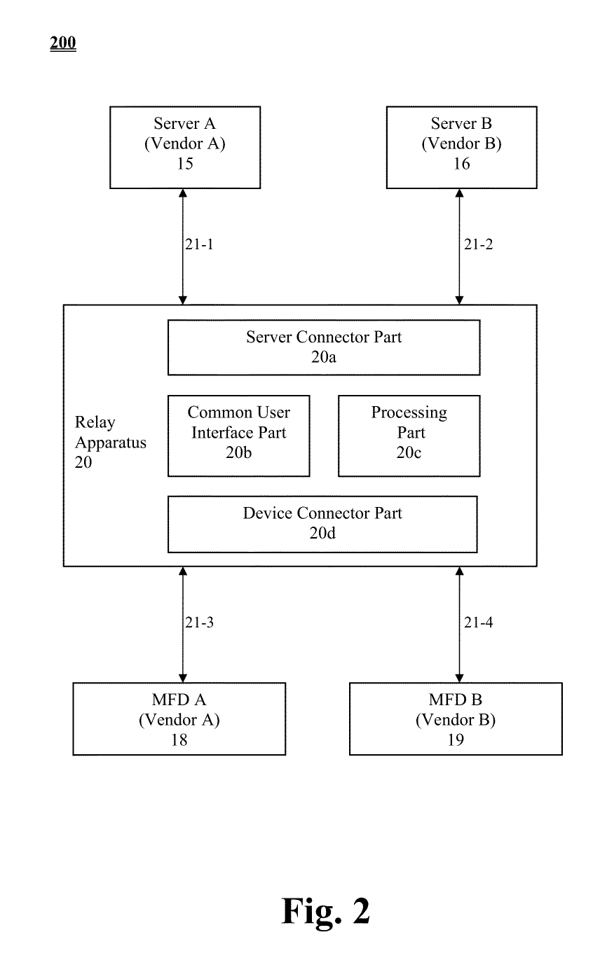

For example, FIG. 2 shows schematically a system 200 for accessing the functionalities of plural heterogeneous multi-function devices and plural heterogeneous server devices. As illustrated in FIG. 2, the system 200 includes plural server devices Server A 15 and Server B 16. According to this non-limiting exemplary embodiment, Server A may be a server device manufactured and/or provided by a Vendor A, whereas server B may be a server device manufactured and/or provided by a Vendor B. Thus, Server A and Server B represent plural heterogeneous server devices that may include different software and provide different services. The system 200 also includes plural MFDs, MFD A 18 and MFD B 19. According to this non-limiting exemplary embodiment, MFD A may be a multi-function device manufactured and/or provided by a Vendor A (the same vendor that provides server A), whereas MFD B may be a multi-function device manufactured and/or provided by a Vendor B (the same vendor that provides server B). Thus, MFD A and MFD B represent plural heterogeneous multi-function devices that may include different software and provide different services.

The system 200 also includes a relay apparatus 20. The relay apparatus 20 includes a server connector part 20a, a common user interface part 20b, a processing part 20c and a device connector part 20d. The plural servers A 15 and B 16 and the relay apparatus 20 may be connected by connections 21-1 and 21-2. Similarly, the plural multi-function devices MFD A 18 and MFD B 19 and the relay apparatus 20 may be connected by connections 21-3 and 21-4. Connection 21-1 through 21-4 may correspond to wired or wireless connections to networks such as the internet, and/or may be wired or wireless direct communication links, as will be described in more detail hereinafter.

The server connector part 20a of the relay apparatus 20 is connectable to the plural server devices and is configured to communicate with each of the plural server devices in a communication format native to each of the plural server devices. For example, if Server A is manufactured and/or provided by Vendor A, then the server connector part 20a is configure to communicate with Server A in a communication format established by Vendor A. Likewise, if Server B is manufactured and/or provided by Vendor B, then the server connector part 20a is configure to communicate with Server B in a communication format established by Vendor B. The server connector part 20a may access an Application Program Interface (API) of each of the plural server devices A 15 and B 16 in order to communicate with each of the plural server devices in a communication format native to each of the plural server devices.

The device connector part 20d of the relay apparatus 20 is connectable to the plural MFDs, MFD A 18 and MFD B 19, and is configured to communicate with each of the plural MFDs in a communication format native to each of the plural MFDs. For example, if MFD A is manufactured and/or provided by Vendor A, then the device connector part 20d is configure to communicate with MFD A in a communication format established by Vendor A. Likewise, if MFD B is manufactured and/or provided by Vendor B, then the device connector part 20d is configure to communicate with MFD B in a communication format established by Vendor B. The device connector part 20d may access an Application Program Interface (API) of each of the plural MFDs, MFD A 15 and MFD B 16, in order to communicate with each of the plural MFDs in a communication format native to each of the plural MFs.

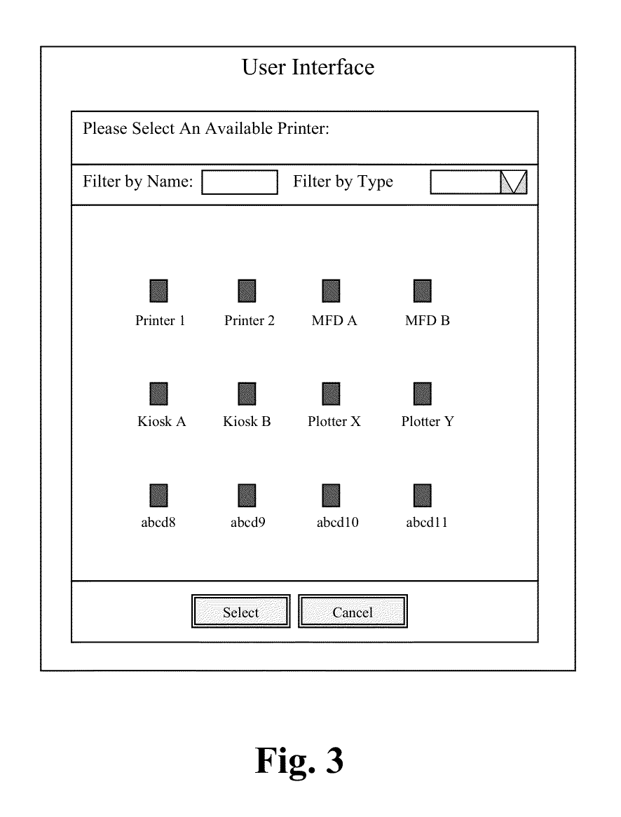

According to this exemplary embodiment, the common user interface part 20b is configured to receive (i) a user selection of a specific one of plural multi-function devices (e.g. MFD A or MFD B) connected to the device connection part 20d of the relay apparatus 20, and (ii) a user instruction to access functionalities of the selected multi-function device. For example, the common user interface part 20b may display a user interface screen on a display unit (LCD, monitor, touchscreen, etc.) of the relay apparatus 20 that allows the user to select a specific one of the plural multi-function devices that are connected to the relay apparatus 20. FIG. 3 illustrates an example of a user interface screen displayed on the relay apparatus 20 that allows a user to select a print device of MFD connected to the relay apparatus 20.

Once the user selects a specific one of the plural multi-function devices (e.g. MFD A or MFD B) (via the user interface screen of FIG. 3, for example), the user may be presented with a common user interface to access the functionalities of the selected multi-function device. Thus, the common user interface of the relay apparatus 20 may essentially replace the user interface panel or operation control panel of the selected multi-function device itself, to the extent that the common user interface displayed by the common user interface part may be utilized to access the functionalities (e.g. copy, scan to email, scan and store, print, fax, etc.) of the selected multi-function device.

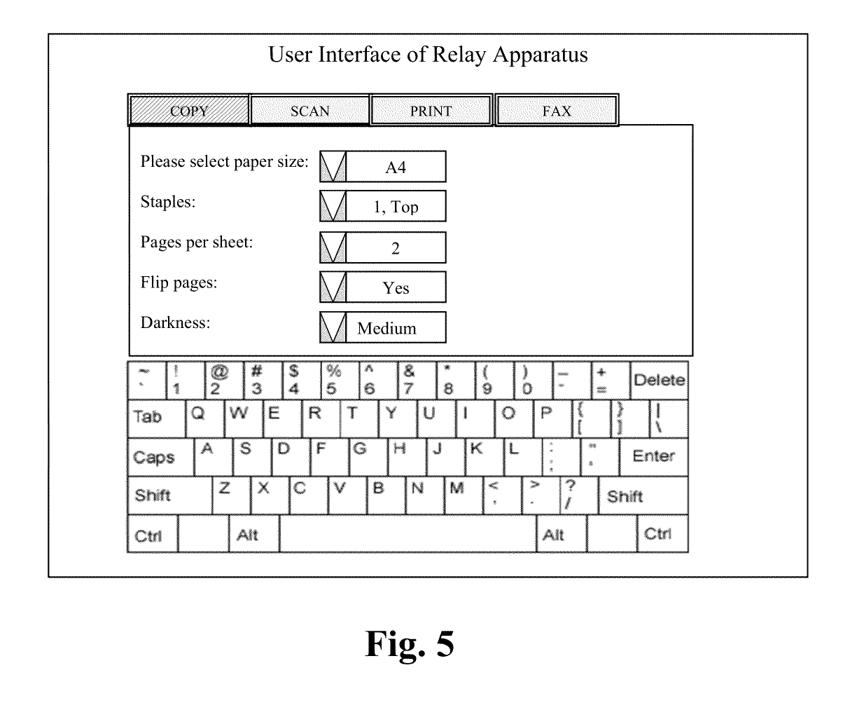

According to an aspect of this embodiment, the common user interface has the same common, generic format regardless of which multi-function device (e.g. MFD A or MFD B) is selected. An example of a common user interface displayed by the common user interface part 20b is illustrated in FIG. 5.

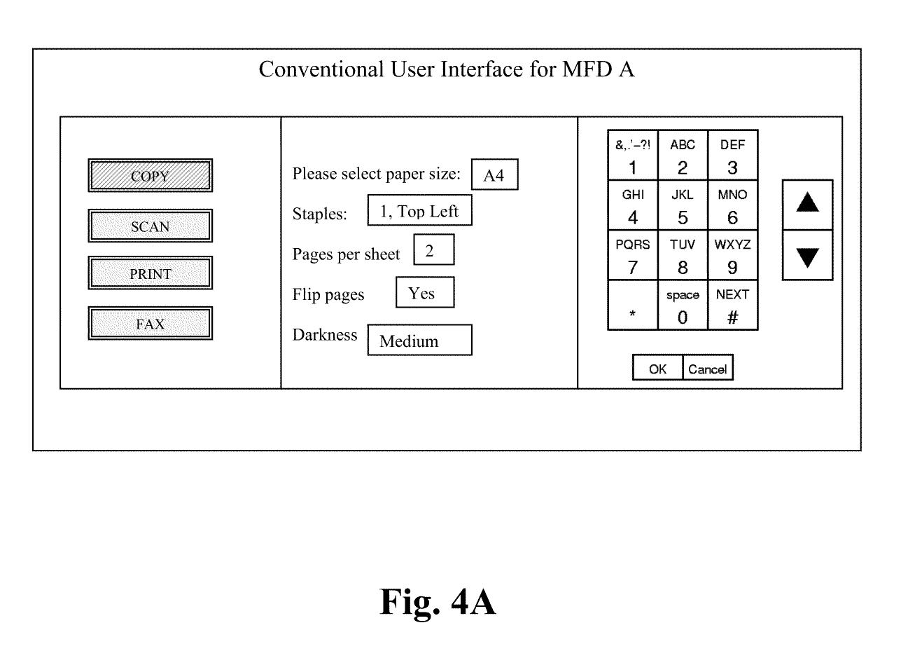

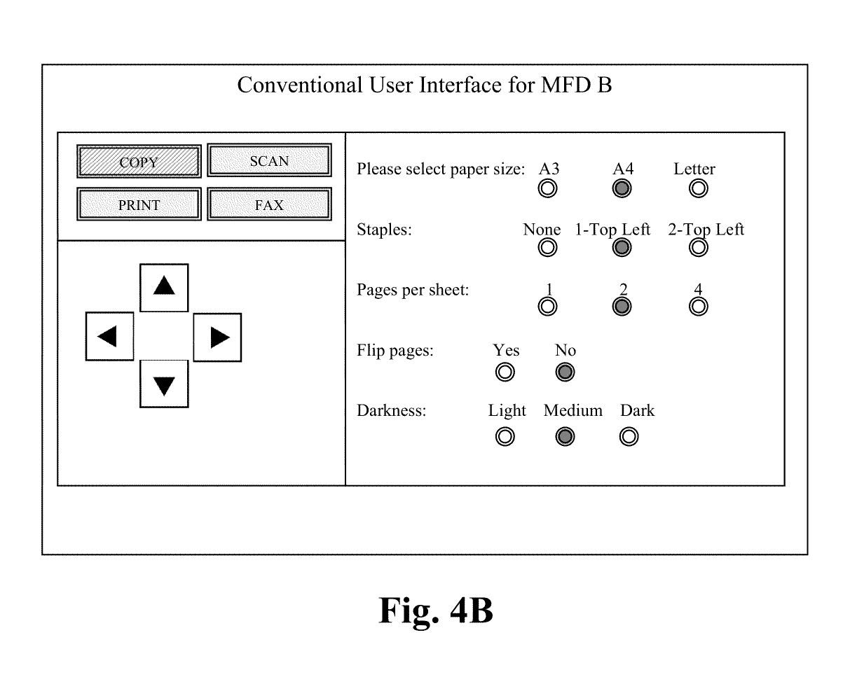

For example, FIG. 4A illustrates an exemplary user interface screen that may be displayed conventionally on a display part or operation control panel of the MFD A 18. As seen in FIG. 4A, the conventional user interface allows a user to access the functionalities (e.g. copy, scan, print, fax, etc.) of MFD A. Moreover, the user interface screen of MFD A has a particular style and format, representing the design aesthetic choices and services corresponding to Vendor A that provides and/or manufactures MFD A. As another example, FIG. 4B illustrates an exemplary user interface screen that may be displayed conventionally on a display part or operation control panel of the MFD B 19. As seen in FIG. 4B, the conventional user interface allows a user to access the functionalities (e.g. copy, scan, print, fax, etc.) of MFD B. The user interface screen of MFD B has a particular style and format, representing the design aesthetic choices and services corresponding to Vendor B that provides and/or manufactures MFD B. As seen in FIG. 4B and FIG. 4A, the format of the conventional user interfaces of MFD A and MFD B are different. Thus, users of the conventional user interfaces of MFD A and MFD B are inconvenienced, in that the users must learn and adjust to the differences between the disparate user interfaces.

In contrast, according to an aspect of this embodiment, the common user interface has the same common, generic format regardless of which of plural multi-function devices (e.g. MFD A or MFD B) is selected. That is, if the user selects MFD A or MFD B, the same user interface screen of FIG. 5 may be displayed in order to access the functionalities of the selected multi-function device (e.g. MFD A or MFD B). The common user interface of FIG. 5 includes tabs to selects a specific function, such as “copy”, “scan”, “print” and “fax.” The common user interface of FIG. 5 also includes a series of pull-down menus with pre-filled options for the user to select in order to specify various options. The pre-filled options in each of the pull-down menus may be customized based on the device capabilities and services available on the selected multi-function device.

After the user of the relay apparatus 20 selects one of the multi-function devices, MFD A and MFD B, (via the user interface of FIG. 3), and after the user of the relay apparatus 20 enters a user instruction to access a functionality of the selected multi-function device (e.g. entering a scan operation instruction or print operation instruction via the common user interface of FIG. 5), the processing part 10c of the relay apparatus 20 is configured to convert the user instruction received by the common user interface part 10b into a format native to the selected multi-function device, and to provide the converted user instruction to the device connector part 20d.

For example, if MFD A is selected and is manufactured and/or provided by Vendor A, processing part 20b is configured to convert the user instruction into a communication format native to MFD A and established by Vendor A. The converted instruction is then provided to the device connector part 20d, which transmits the converted instruction to MFD A in the communication format native to MFD A and established by Vendor A. As another example, if MFD B is selected and is manufactured and/or provided by Vendor B, processing part 20b is configured to convert the user instruction into a communication format native to MFD B and established by Vendor B. The converted instruction is then provided to the device connector part 20d, which transmits the converted instruction to MFD B in the communication format native to MFD B and established by Vendor B. The processing part 20c may access an Application Program Interface (API) of each of the plural MFDs A 18 and B 19 in order to convert eh user instruction received by the common user interface part 20b into the format native to the selected multi-function device.

After the device connector part 20d transmits the user instruction to the selected multi-function device (e.g. scan operation instruction or print operation instruction), the device connector part 20d may also receive data from the selected multi-function device. For example, if the user instruction corresponds to a scan operation instruction, the device connector part 20d may receive scan image data from the selected MFD, which still has to be transmitted to one of the servers A 15 and B 16 for storage. As another example, if the user instruction corresponds to a print operation instruction, the device connector part 20d may receive a data request for print data from the selected MFD, and the data request may still have to be transmitted to one of the servers A 15 and B 16 in order to obtain the requested data from the appropriate server A or B. Any data received at the device connector part 20d from the selected multi-function device will be in the format native to the selected multi-function device.

According to an aspect of this exemplary embodiment, the processing part determines, based on the user instruction, a specific server device from among the plural server devices to receive the data returned from the selected multi-function device.

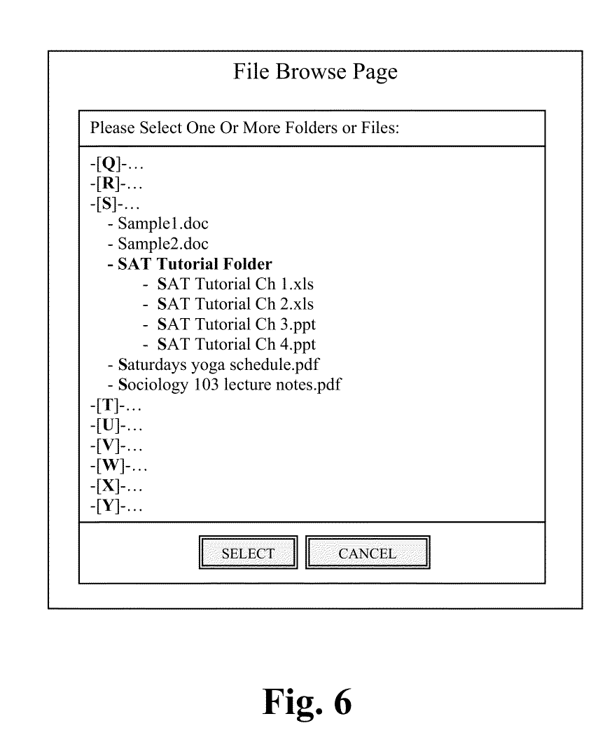

For example, if the user instruction is a scan operation instruction to scan data, the user instruction will typically include a user specification of a storage location on one of the plural server devices for storing the resulting scan image data. For example, the common user interface part may display the user interface screen of FIG. 6 to allow the user to select a storage location and/or storage file for storing the resulting scan image data. The processing part 20c will determine which server device, server A and server B, stores the user-designated filed. Thus, after the device connector part 20d receives scan image data from the selected MFD, which still has to be transmitted to one of the servers A 15 and B 16 for storage, the processing part determines a specific server device from among the plural server devices based on the user instruction, and converts (i) the data received by the device connector part (which is in the format native to the selected multi-function device) and (ii) the user instruction, into a format native to the specific server device. Thereafter, the server connector part 20a transmits the converted scan image data and converted user instruction to the specific server device in the format native to the specific server device, to access the functionalities of the specific server device based on the user instruction (i.e. to store the scan image data at the user designated location).

As another example, if the user instruction is a print operation instruction to print data, the user instruction will typically include a user specification of a file or document stored at a storage location connected to one of the plural server devices for printing. For example, the common user interface part may display the user interface screen of FIG. 6 to allow the user to specify a file or document stored at a storage location connected to one of the plural server devices for printing. The processing part 20c will determine which server device, server A and server B, corresponds to the user designated storage location and/or storage file. Thus, after the device connector part 20d receives a data request for print data from the selected MFD, the processing part determines a specific server device from among the plural server devices based on the user instruction, and converts (i) the data request received by the device connector part (which is in the format native to the selected multi-function device) and (ii) the user instruction, into a format native to the specific server device. Thereafter, the server connector part 20a transmits the converted data request and converted user instruction to the specific server device in the format native to the specific server device, to access the functionalities of the specific server device based on the user instruction (i.e. to request the user-specified file stored at the storage location connected to the particular server device). After the specific server device responds with the requested file, the data can be forward to the selected multi-function device for printing.

Thus, in this exemplary embodiment, there is provided a tool (for example, an apparatus, mobile print application software, etc.) for accessing the functionalities of plural heterogeneous multi-function devices and plural heterogeneous server devices provided by different vendors.

That is, conventionally each vendor typically has an established set of software, communication protocols and data formats, and there is a drawback in that MFD A and server A communicate with each other using a first communication format established by vendor A, while MFD B and server B communicate with each other using a second communication format established by vendor B. Thus, conventionally a user of MFD A may be able to access the functionalities offered by server A (such as being able to access documents, data and software stored on server A), while not being able to access the functionalities offered by server B, since MFD A and server B use different communication formats and are unable to fully communicate with each other.

In contrast, the relay apparatus of this exemplary embodiment includes a server connector part connected to plural heterogeneous server devices provided by different vendors, a device connector part connected to plural heterogeneous multi-function devices provided by different vendors, and a common user interface part to receive user instructions utilizing a common user interface. The relay apparatus functions as a ‘black box system’ transparent to the user, and permits the user to operate any MFD (e.g. MFD A or MFD B in FIG. 2) by accessing the functionalities of any server device (e.g. server A or Server B in FIG. 2), and vice versa.

Moreover, while the conventional user interface of MFD A will typically have a different presentation format, layout and style, etc., compared to the user interface of MFD B, the common user interface of this embodiment may be utilized by the user to operate all the MFDs, as if the user were actually operating the user interface screen of each respective MFD. Thus, the common user interface of this disclosure acts as a unified interface that can replace the need for the user to operate the different user interface screens of all the MFDs.

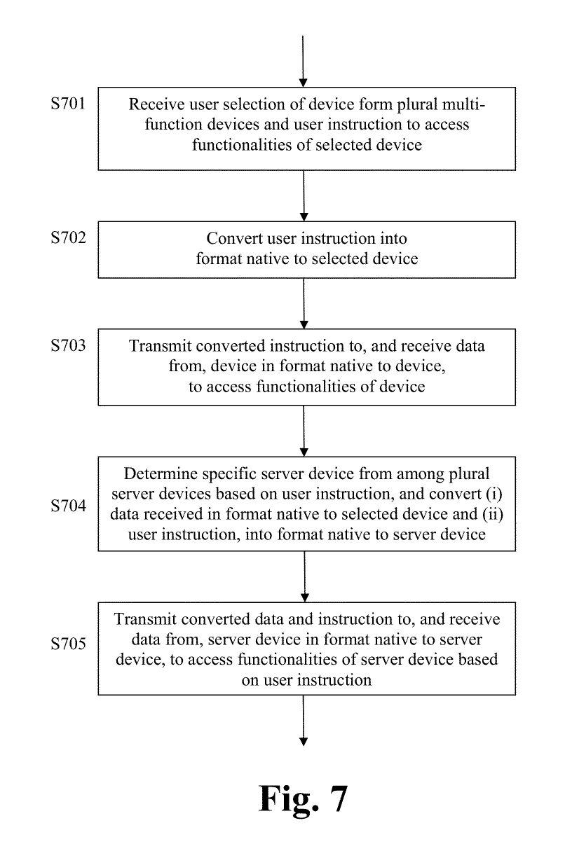

Turning now to FIG. 7, there is shown a flowchart of a method performed by a relay apparatus, such as relay apparatus 20 illustrated in FIG. 2, according to an exemplary embodiment.

In S701, the common user interface part 20b of the relay apparatus 20 receives by a user selection of a specific one of the plural multi-function devices, MFD A and MFD B, and a user instruction to access functionalities of the selected multi-function device. In S702, the processing part 20c of the relay apparatus 20 converts the user instruction received by the common user interface part 20b into a format native to the selected multi-function device. In S703, the device connector part 20d of the relay apparatus 20 (which is connectable to the plural multi-function devices MFD A and MFD B), transmits the converted user instruction to the selected multi-function device in the format native to the selected multi-function device, to access said functionalities of the selected multi-function device. The device connector part 20d may also receive data from the selected multi-function device.

In S704, the processing part 20c determines a specific server device from among plural server devices, server A and server B, based on the user instruction, and converts (i) the data received by the device connector part 20d in the format native to the selected multi-function device and (ii) the user instruction, into a format native to the specific server device. In S705, the server connector part 20a of the relay apparatus 20 (which is connectable to the plural server devices, server A and server B) transmits the converted data and instruction to the specific server device in the format native to the specific server device, to access the functionalities of the specific server device based on the user instruction. The server connector part 20a may also receive data from the specific server device.

The relay apparatus 20 of this disclosure may be realized by an application or computer program product including a computer-usable, non-transient medium (such as a disk storage apparatus) having instructions tangibly embodied therein that are executed by a computer. Thus, it should be understood that the apparatus 20 may be executed on a computer, a client terminal and/or network-connected device. The components of the relay apparatus 20 such as the common user interface part 20b and the processing part 20c may be manifested as software components corresponding to aforementioned application.

The apparatus 20 may include a data store that can comprise one or more structural or functional parts that have or support a storage function. For example, the data store can be, or can be a component of, a source of electronic data, such as a document access apparatus, a backend server connected to a document access apparatus, an e-mail server, a file server, a multi-function peripheral device (MFP or MFD), a voice data server, an application server, a computer, a network apparatus, a terminal etc. It should be appreciated that the term “electronic document” or “electronic data”, as used herein, in its broadest sense, can comprise any data that a user may wish to access, retrieve, review, etc.

The network connections 21-1 through 21-4 may be provided via one or more of a secure intranet or extranet local area network, a wide area network (WAN), any type of network that allows secure access, etc., or a combination thereof. Further, other secure communications links (such as a virtual private network, a wireless link, etc.) may be used as well as the network connections. In addition, the network connections 21-1 through 21-4 may use TCP/IP (Transmission Control Protocol/Internet Protocol), but other protocols such as SNMP (Simple Network Management Protocol) and HTTP (Hypertext Transfer Protocol) can also be used. How devices can connect to and communicate over the networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

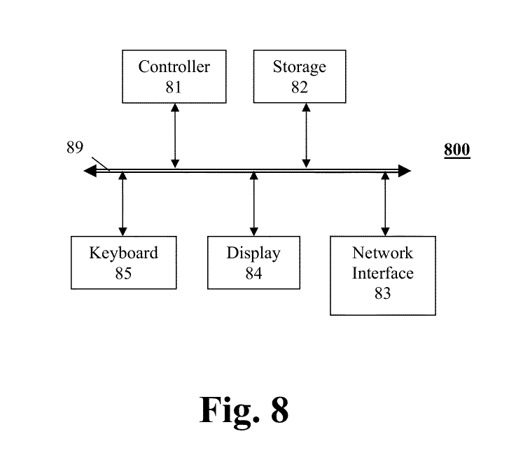

FIG. 8 shows an exemplary constitution of an apparatus as a computer, for example, that can be configured through software to provide the relay apparatus 20 illustrated in FIG. 2. As shown in FIG. 8, the computer 800 includes a controller (or central processing unit) 81 that communicates with a number of other components, including memory or storage part 82, network interface 83, display 84 and keyboard 85, by way of a system bus 89.

The computer 800 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as will be appreciated to those skilled in the relevant arts.

In computer 800, the controller 81 executes program code instructions that controls device operations. The controller 81, memory/storage 82, network interface 83, display 84 and keyboard 85 are conventional, and therefore in order to avoid occluding the inventive aspects of this disclosure, such conventional aspects will not be discussed in detail herein.

The computer 800 includes the network interface 83 for communications through a network, such as communications through the networks 21-3 through 21-4 with the plural servers A and B and plural multi-function devices MFDA and MFD B illustrated in FIG. 2. However, it should be appreciated that the subject matter of this disclosure is not limited to such configuration. For example, the apparatus 800 may communicate with client terminals through direct connections and/or through a network to which some components are not connected. As another example, the apparatus 800 need not be provided by a server that services terminals, but rather may communicate with the devices on a peer basis, or in another fashion.

Apparatus 20 is not limited to a computer or server, but can be manifested in any of various devices that can be configured to communicate over a network and/or the Internet.

The apparatus 20, multi-function devices MFD A and MFD B and/or the server devices, server A and server B, may be any network-connected device including but not limited to a personal, notebook or workstation computer, a terminal, a kiosk, a PDA (personal digital assistant), a tablet computing device, a smartphone, a scanner, a printer, a plotter, a facsimile machine, a multi-function device (MFD), a server, a mobile phone or handset, another information terminal, etc. Each device may be configured with software allowing the device to communicate through networks with other devices.

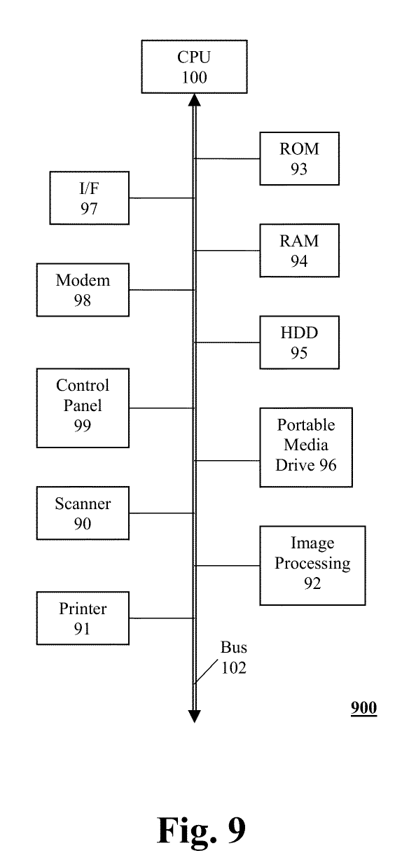

An example of a configuration of a multi-function device (MFD) is shown schematically in FIG. 9. Device 900 includes a central processing unit (CPU) 100, and various elements connected to the CPU 100 by an internal bus 102. The CPU 100 services multiple tasks while monitoring the state of the device 900. The elements connected to the CPU 100 include a scanner unit 90, a printer unit 91, an image processing device 92, a read only memory (for example, ROM, PROM, EPROM, EEPROM, etc.) 93, a random access memory (RAM) 94, a hard disk drive (HDD) 95, portable media (for example, floppy disk, optical disc, magnetic discs, magneto-optical discs, semiconductor memory cards, etc.) drives 96, a communication interface (I/F) 97, a modem unit 98, and an operation panel 99.

Program code instructions for the device 900 can be stored on the read only memory 93, on the HDD 95, or on portable media and read by the portable media drive 96, transferred to the RAM 94 and executed by the CPU 100 to carry out the instructions. These instructions can include the instructions to the device to perform specified ones of its functions and permit the device 900 to interact with other network connected devices.

The operation panel 99 includes a display screen that displays information allowing the user of the device 900 to operate the device 900. The display screen can be any of various conventional displays (such as a liquid crystal display, a plasma display device, a cathode ray tube display, etc.), but is preferably equipped with a touch sensitive display (for example, liquid crystal display), and configured to provide the GUI based on information input by an operator of the device, so as to allow the operator to conveniently take advantage of the services provided by the system. The display screen does not need to be integral with, or embedded in, the operation panel 99, but may simply be coupled to the operation panel by either a wire or a wireless connection. The operation panel 99 may include keys for inputting information or requesting various operations. Alternatively, the operation panel 99 and the display screen may be operated by a keyboard, a mouse, a remote control, touching the display screen, voice recognition, or eye-movement tracking, or a combination thereof. The device 900 is a multifunction device (with scanner, printer and image processing) and in addition can be utilized as a terminal to download documents from a network.

Additional aspects or components of the device 900 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

Referring back to FIG. 2, according to another aspect of this embodiment, if the user instruction received via the common user interface part 20b corresponds to a scan operation instruction, the processing part 20c converts the scan operation instruction into the format native to the selected multi-function device (e.g. MFD A or MFD B), the device connector part 20d transmits the converted scan operation instruction to the selected multi-function device to cause the selected multi-function device to perform the scan operation, and receives scan image data from the selected multi-function device in the format native to the selected multi-function device.

The processing part 20c then determines a specific one of the servers devices (e.g. server A or server B) to be a destination for storing the scan image data, based on the user instruction. For example, if the user instruction is a scan operation instruction to scan data, the user instruction will typically include a user specification of a storage location on one of the plural server devices for storing the resulting scan image data. For example, the common user interface part may display the user interface screen of FIG. 6 to allow the user to select a storage location and/or storage file for storing the resulting scan image data. The processing part 20c will determine which server device, server A and server B, stores the user-designated filed. Thus, after the device connector part 20d receives scan image data from the selected MFD, which still has to be transmitted to one of the servers A 15 and B 16 for storage, the processing part determines a specific server device from among the plural server devices based on the user instruction, and converts (i) the data received by the device connector part (which is in the format native to the selected multi-function device) and (ii) the user instruction, into a format native to the specific server device. Thereafter, the server connector part 20a transmits the converted scan image data and converted user instruction to the specific server device in the format native to the specific server device, to access the functionalities of the specific server device based on the user instruction (i.e. to store the scan image data at the user designated location).

According to the aforementioned aspects, if the scan operation instruction (i.e. user instruction received via common user interface part 20b) includes an instruction to store the scan image data in a particular storage unit connected to the specific server device, the server connector part 20a transmits the converted scan image data and scan operation instruction to the specific server device in the format native to the specific server device, to cause the specific server device store the scan image data in the particular storage unit. On the other hand, if the scan operation instruction (i.e. user instruction received via common user interface part 20b) includes an instruction to email the scan image data to a particular email address, the server connector part 20a transmits the converted scan image data and scan operation instruction to the specific server device in the format native to the specific server device, to cause the specific server device to email the scan image data to the particular email address. The specific server device may correspond to, for example, an email server such as a Simple Mail Transfer Protocol (SMTP) server.

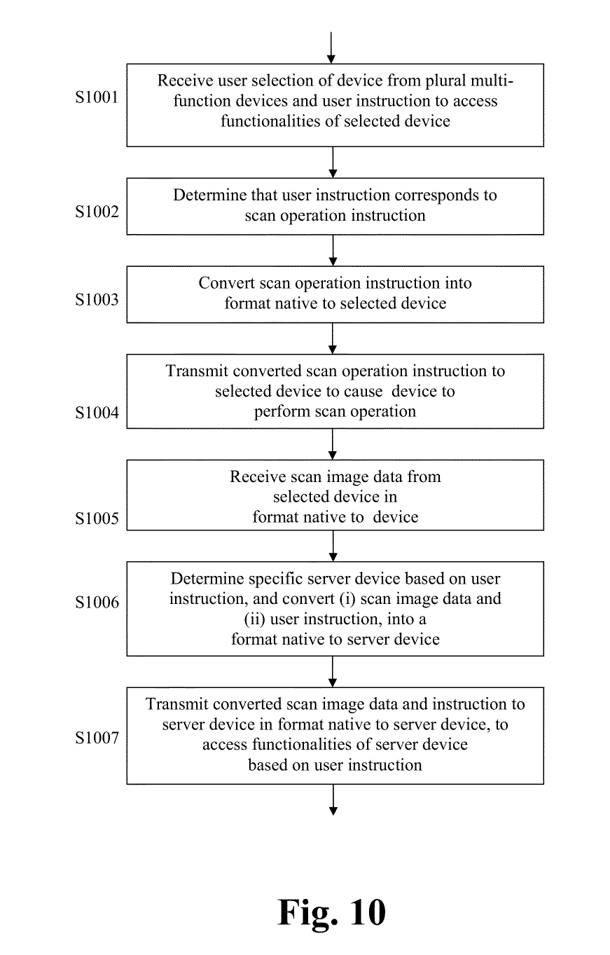

In FIG. 10, there is shown a flowchart of a method performed by a relay apparatus, such as relay apparatus 20 illustrated in FIG. 2, according to an exemplary embodiment.

In S1001, the common user interface part 20b of the relay apparatus 20 receives by a user selection of a specific one of the plural multi-function devices (e.g. MFD A or MFD B), and a user instruction to access functionalities of the selected multi-function device. In S1002, the processing part 20c determines that the user instruction corresponds to a scan operation instruction, and in S1003 converts the scan operation instruction into the format native to the selected multi-function device. In S1004, the device connector part 20d transmits the converted scan operation instruction to the selected multi-function device to cause the selected multi-function device to perform the scan operation, and in S1005 receives scan image data from the selected multi-function device in the format native to the selected multi-function device.

In S1006, the processing part 20c determines a specific server device from among plural server devices (e.g. server A or server B) for receiving the scan image data, based on the user instruction, and converts (i) the scan image data received by the device connector part 20d in the format native to the selected multi-function device and (ii) the user instruction, into a format native to the specific server device. In S1007, the server connector part 20a transmits the converted scan image data and the converted user instruction to the specific server device in the format native to the specific server device, to access the functionalities of the specific server device (i.e. store the scan image data at a storage location connected to the specific server device) based on the user instruction.

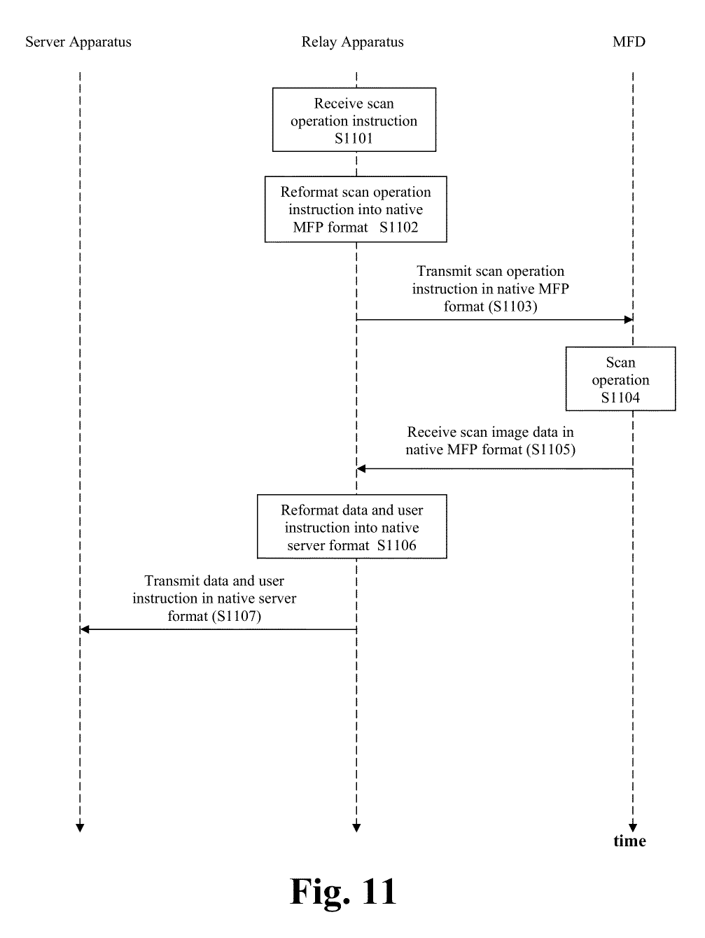

In FIG. 11, there is shown a schematic diagram of a data flow in a system, such as system 200 illustrated in FIG. 2, according to an exemplary embodiment.

In S1101, the relay apparatus 20 receives a user selection of a specific one of the plural multi-function devices (e.g. MFD A or MFD B), and a user instruction corresponding to a scan operation instruction. In S1102, the relay apparatus converts/reformats the scan operation instruction into the format native to the selected multi-function device. In S1103, the relay apparatus 20 transmits the converted scan operation instruction to the selected multi-function device to cause the selected multi-function device to perform the scan operation, and in S1104 the selected multi-function device performs the scan operation. In S1105, the relay apparatus receives scan image data from the selected multi-function device in the format native to the selected multi-function device, and in S1106, the relay apparatus 20 converts (i) the scan image data in the format native to the selected multi-function device and (ii) the user instruction, into a format native to the specific server device. In S1107, the relay apparatus 20 transmits the converted scan image data and the converted user instruction to the specific server device in the format native to the specific server device, to access the functionalities of the specific server device (i.e. store the scan image data at a storage location connected to the specific server device) based on the user instruction.

Referring back to FIG. 2, according to another aspect of this embodiment, if the user instruction received via the common user interface part 20b corresponds to a print operation instruction, the processing part 20c converts the print operation instruction into the format native to the selected multi-function device (e.g. MFD A or MFD B), the device connector part 20d transmits the converted print operation instruction to the selected multi-function device to cause the selected multi-function device to process the print operation instruction, and receives a data request from the selected multi-function device in the format native to the selected multi-function device.

The processing part 20c then determines a specific one of the server devices (e.g. server A or server B) that stores the document or file that the user wishes to print. For example, if the user instruction is a print operation instruction to print data, the user instruction will typically include a user specification of a file or document stored at a storage location connected to one of the plural server devices for printing. The processing part 20c will determine which server device (e.g. server A or server B) corresponds to the user designated storage location and/or storage file. Thus, after the device connector part 20d receives a data request for print data from the selected MFD, the processing part determines a specific server device from among the plural server devices based on the user instruction, and converts (i) the data request received by the device connector part (which is in the format native to the selected multi-function device) and (ii) the user instruction, into a format native to the specific server device. Thereafter, the server connector part 20a transmits the converted data request and converted user instruction to the specific server device in the format native to the specific server device, to access the functionalities of the specific server device based on the user instruction (i.e. to request the user-specified file stored at the storage location connected to the particular server device).

After the specific server device responds with the requested file or document data, the processing part 20c converts the document data into print data in the format native to the selected multi-function device, e.g. Printer Description Language (PDL), Printer Control Language (PCL), PostScript, etc. The device connector part 20d transmits the print data to the selected multi-function device to cause the selected multi-function device to perform the print operation.

The processing part 20c may convert the document data into any standard printable format printable by the selected multi-function device e.g. Printer Description Language (PDL), Printer Control Language (PCL), PostScript, etc. This may be particularly useful in the case where the selected multi-function device is newly discovered or recently connected to the device connector part 20d, and thus a particular format native to the selected multi-function device may not yet have been ascertained.

Since the relay apparatus converts document data into print data printable by the selected multi-function device, the relay apparatus functions as a ‘black box’ printer driver, eliminating the need for any printer drivers to be installed on any of the server devices, on any of the multi-function devices, or on any user terminals connected to the relay apparatus that may request a print job, and so forth.

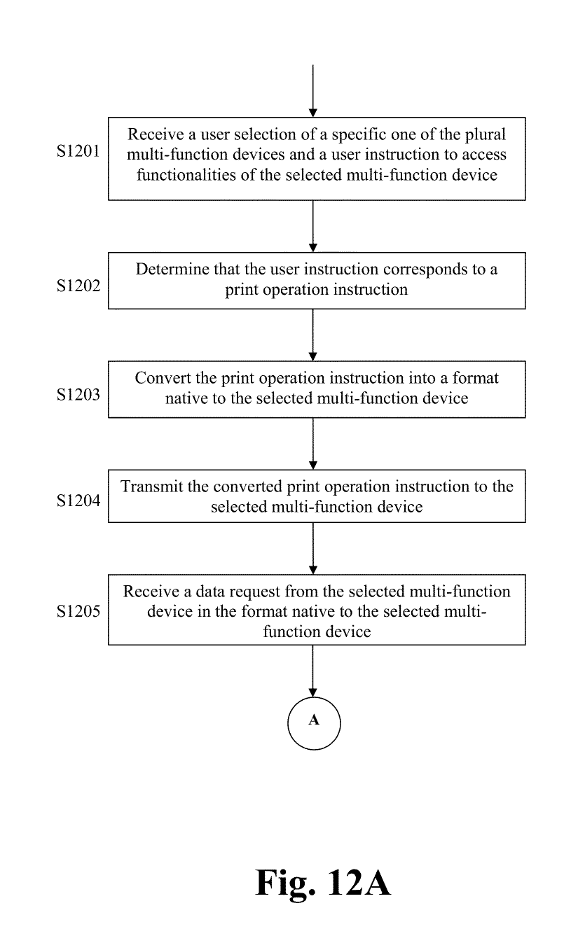

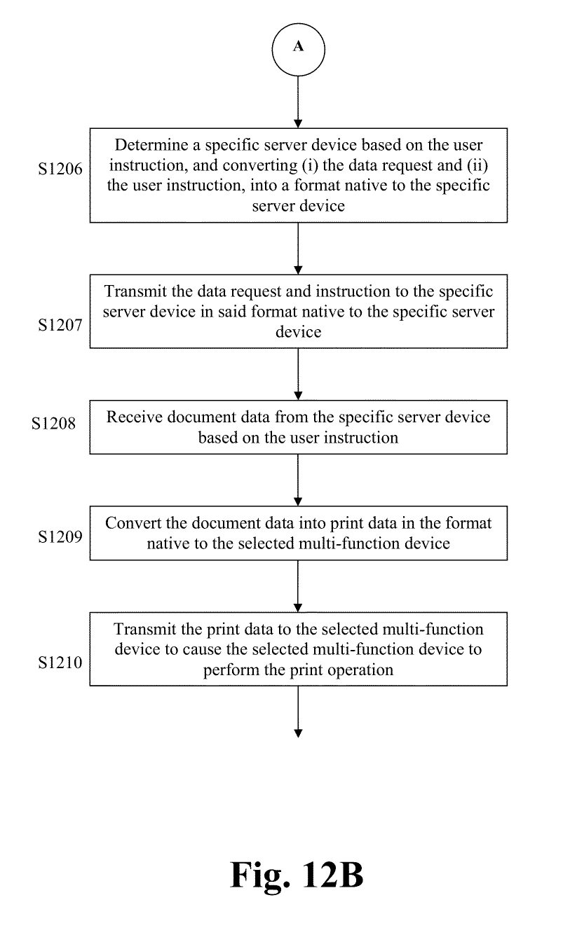

In FIGS. 12A and 12B, there is shown a flowchart of a method performed by a relay apparatus, such as relay apparatus 20 illustrated in FIG. 2, according to an exemplary embodiment.

In S1201, the common user interface part 20b of the relay apparatus 20 receives by a user selection of a specific one of the plural multi-function devices (e.g. MFD A or MFD B), and a user instruction to access functionalities of the selected multi-function device. In S1202, the processing part 20c determines that the user instruction corresponds to a print operation instruction, and in S1203 converts the print operation instruction into the format native to the selected multi-function device. In S1204, the device connector part 20d transmits the converted print operation instruction to the selected multi-function device, and in S1205 receives data request from the selected multi-function device in the format native to the selected multi-function device.

In S1206, the processing part 20c determines a specific server device from among plural server devices (e.g. server A or server B) for receiving the data request, based on the user instruction, and converts (i) the data request received by the device connector part 20d in the format native to the selected multi-function device and (ii) the user instruction, into a format native to the specific server device. In S1207, the server connector part 20a transmits the converted data request and the converted user instruction to the specific server device in the format native to the specific server device, to access the functionalities of the specific server device (i.e. to request the document data from a storage location connected to the specific server device) based on the user instruction.

In S1208, the server connector part 20a receives document data from the specific server device based on the user instruction, and in S1209 the processing part 20c converts the document data into print data in the format native to the selected multi-function device. Finally, in S1209, the device connector part 20d transmits the print data to the selected multi-function device to cause the selected multi-function device to perform the print operation and print the print data.

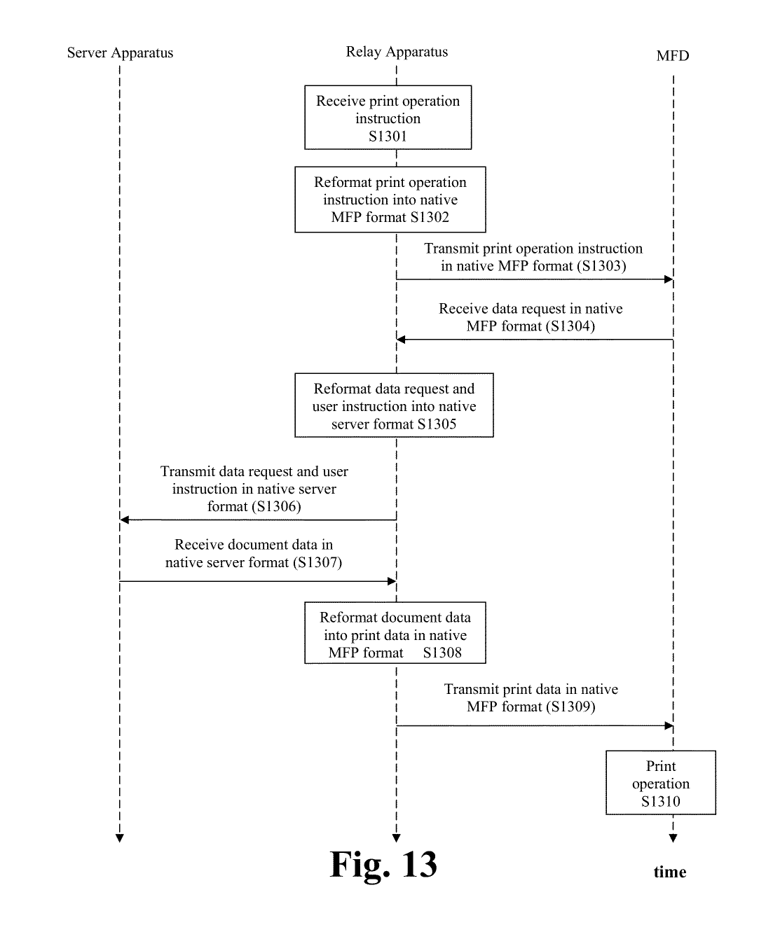

In FIG. 13, there is shown a schematic diagram of a data flow in a system, such as system 200 illustrated in FIG. 2, according to an exemplary embodiment.

In S1301, the relay apparatus 20 receives a user selection of a specific one of the plural multi-function devices (e.g. MFD A or MFD B), and a user instruction corresponding to a print operation instruction. In S1302, the relay apparatus converts/reformats the print operation instruction into the format native to the selected multi-function device. In S1303, the relay apparatus 20 transmits the converted print operation instruction to the selected multi-function device, and in S1304 the relay apparatus receives a data request from the selected multi-function device in the format native to the selected multi-function device. In S1305, the relay apparatus 20 converts (i) the data request in the format native to the selected multi-function device and (ii) the user instruction, into a format native to the specific server device. In S1306, the relay apparatus 20 transmits the converted data request and the converted user instruction to the specific server device in the format native to the specific server device, to access the functionalities of the specific server device (i.e. to request the document data from a storage location connected to the specific server device) based on the user instruction.

In S1307, the relay apparatus receives document data from the specific server device based on the user instruction, and in S1308 the relay apparatus converts the document data into print data in the format native to the selected multi-function device. Finally, in S1308, the relay apparatus transmits the print data to the selected multi-function device to cause the selected multi-function device to perform the print operation in S1310 and print the print data.

Referring back to FIG. 2, according to another aspect of this embodiment, if the user instruction received via the common user interface part 20b corresponds to a print operation instruction, the processing part 20c then determines a specific one of the server devices (e.g. server A or server B) that stores the document or file that the user wishes to print. For example, if the user instruction is a print operation instruction to print data, the user instruction will typically include a user specification of a file or document stored at a storage location connected to one of the plural server devices for printing. The processing part 20c will determine which server device (e.g. server A or server B) corresponds to the user designated storage location and/or storage file.

The processing part 20c then generates a print data request in the format native to the specific server device, based on the print operation instruction, the server connector part 20a transmits the print data request to the specific server device, and the server connector part 20a receives document data from the specific server device. The processing part 20c then converts the document data into print data in the format native to the selected multi-function device, e.g. Printer Description Language (PDL), Printer Control Language (PCL) or PostScript, and converts the print operation instruction into the format native to the selected multi-function device. Finally, the device connector part 20d transmits the converted print data and print operation instruction to the selected multi-function device, to cause the selected multi-function device to perform the print operation.

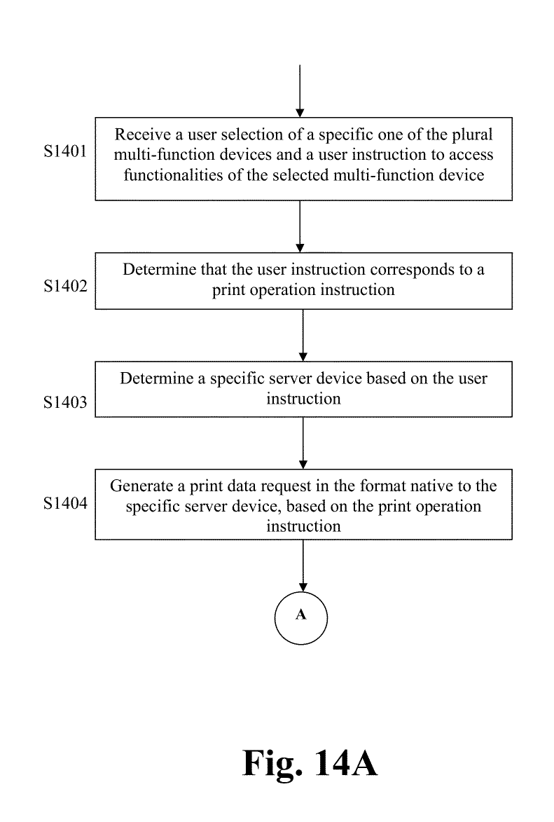

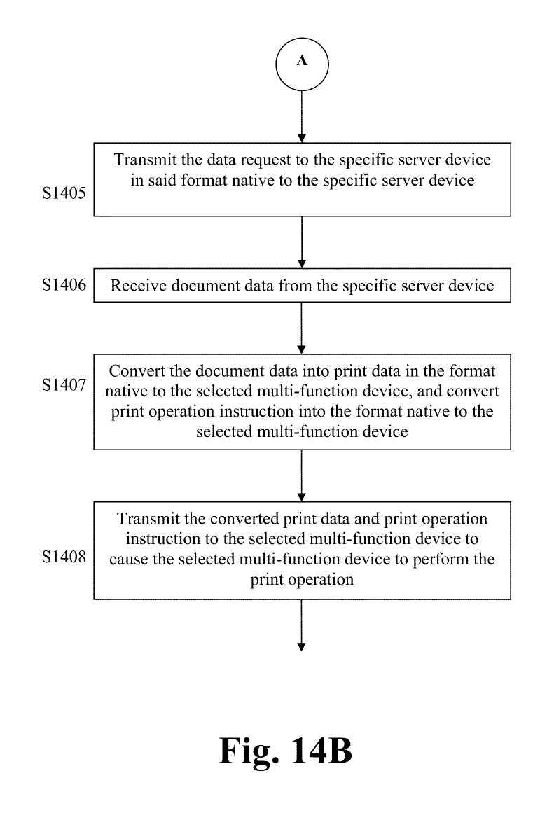

In FIGS. 14A and 14B, there is shown a flowchart of a method performed by a relay apparatus, such as relay apparatus 20 illustrated in FIG. 2, according to an exemplary embodiment.

In S1401, the common user interface part 20b of the relay apparatus 20 receives by a user selection of a specific one of the plural multi-function devices (e.g. MFD A or MFD B), and a user instruction to access functionalities of the selected multi-function device. In S1402, the processing part 20c determines that the user instruction corresponds to a print operation instruction. In S1403, the processing part 20c determines a specific server device from among plural server devices (e.g. server A or server B) for receiving a data request, based on the user instruction, and in S1404 generates a print data request in the format native to the specific server device, based on the print operation instruction. In S1405, the server connector part 20a transmits the print data request to the specific server device, and in S1406 receives document data from the specific server device. In S1407, the processing part 20c converts the document data into print data in the format native to the selected multi-function device, and converts the print operation instruction into the format native to the selected multi-function device. Finally, in S1408, the device connector part 20d transmits the converted print data and print operation instruction to the selected multi-function device, to cause the selected multi-function device to perform the print operation.

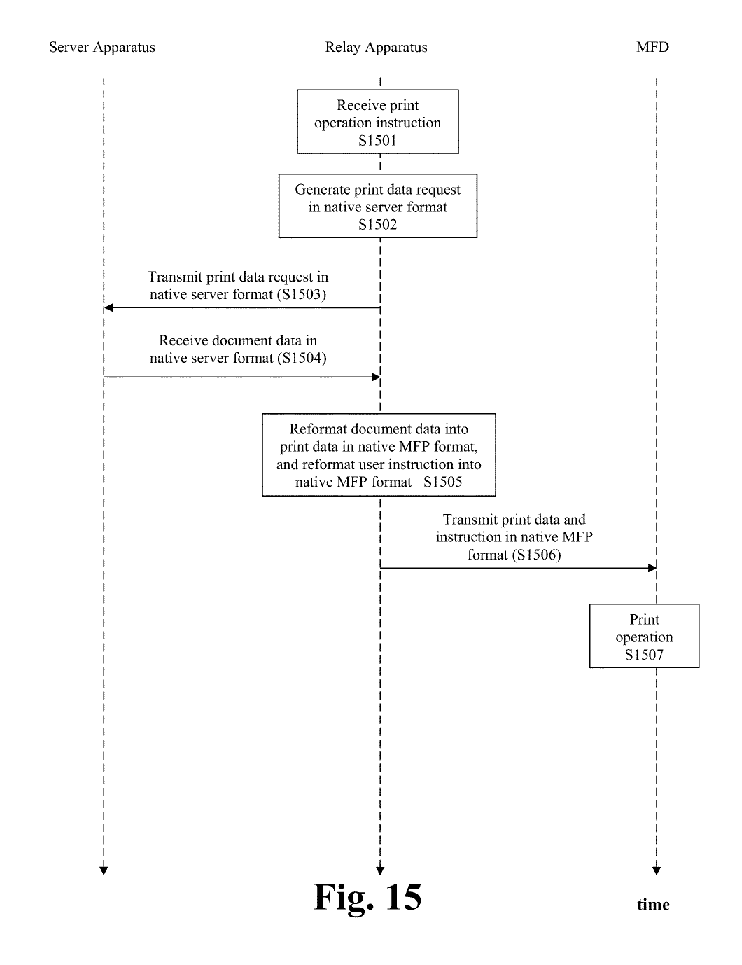

In FIG. 15, there is shown a schematic diagram of a data flow in a system, such as system 200 illustrated in FIG. 2, according to an exemplary embodiment.

In S1501, the relay apparatus 20 receives a user selection of a specific one of the plural multi-function devices (e.g. MFD A or MFD B), and a user instruction corresponding to a print operation instruction. In S1502, the relay apparatus generates a print data request in the format native to the specific server device, based on the print operation instruction. In S1503, the relay apparatus transmits the print data request to the specific server device, and in S1504 receives document data from the specific server device. In S1505, the relay apparatus converts the document data into print data in the format native to the selected multi-function device, and converts the print operation instruction into the format native to the selected multi-function device. Finally, in S1506, the relay apparatus transmits the converted print data and print operation instruction to the selected multi-function device, to cause the selected multi-function device to perform the print operation in S1507.

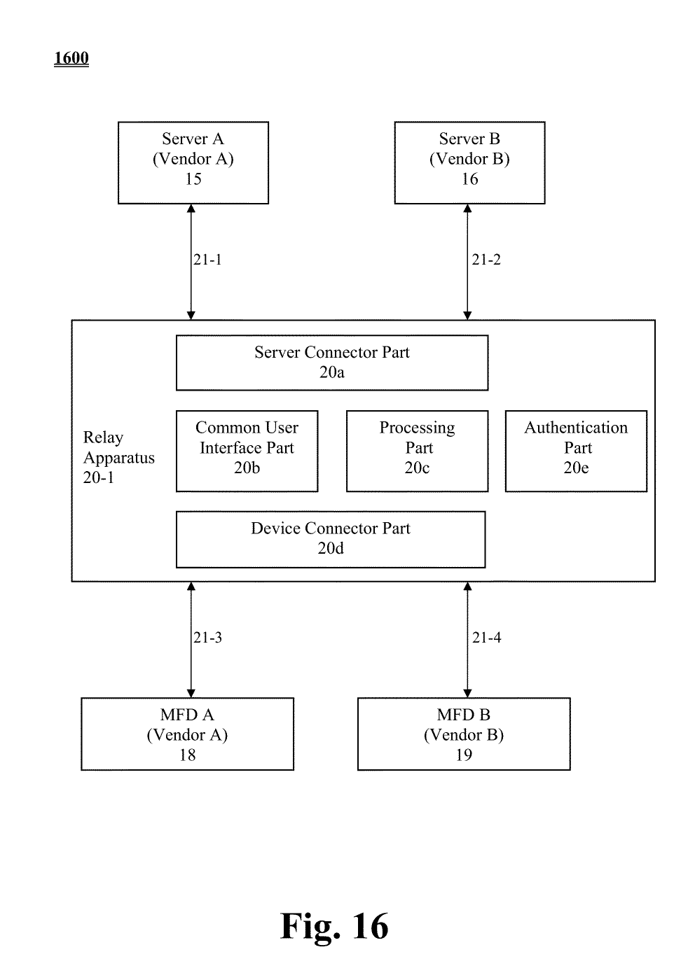

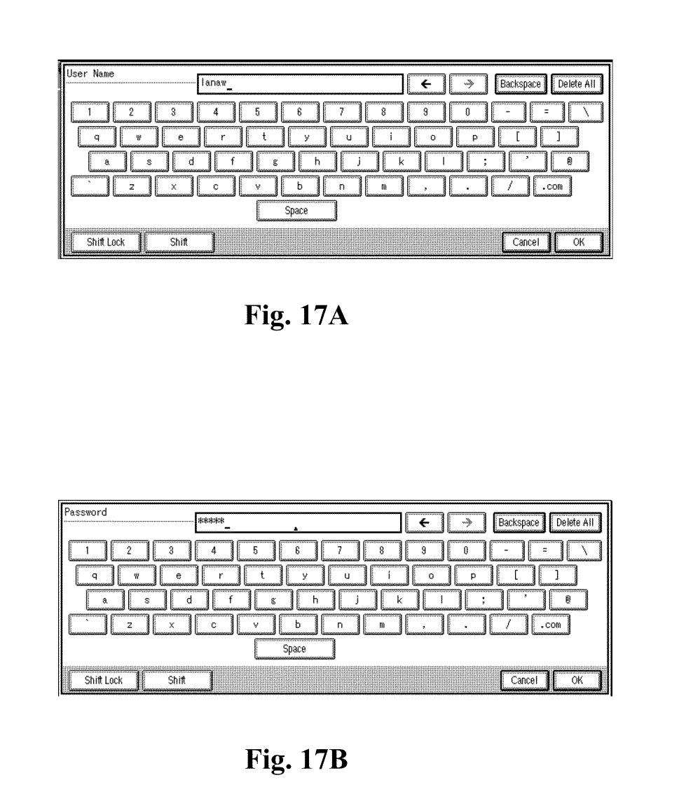

Turning now to FIG. 16, there is described another embodiment of this disclosure. In FIG. 16 there is illustrated a system 1600 similar to the system 200 illustrated in FIG. 2, with relay apparatus 20-1 of FIG. 16 being similar to relay apparatus 20 of FIG. 2, except that relay apparatus 20-1 further includes an authentication part 20e. The authentication part 20e is configured to authenticate the user of the relay apparatus. For example, the authentication part may display a user interface screen on a display part of the relay apparatus to permit the user to enter a username and password to be authenticated. FIG. 17A illustrates an example of a user interface screen that may be displayed on the relay apparatus in order to permit a user to enter their username. FIG. 17B illustrates an example of a user interface screen that may be displayed on the relay apparatus in order to permit a user to enter their password. The user's username and password may be authenticated against an authentication server (e.g. using Lightweight Directory Access Protocol or Active Directory, etc.). Instead, or in addition, the user's username and password may be authenticated against a local address book stored at the relay apparatus.

Other methods of authentication may also be used. For example, the relay apparatus 20-1 may be equipped with one or more biometrics means (such as comparing fingerprints, palm prints, voice or speech, retinas or irises, facial expressions or features, signature, etc.). As another example, the relay apparatus 20-1 may be equipped with a card reader to read an Identification Card or IC card of the user, in order to authenticate the user by checking the identification information, profile information, username, password, etc. stored on the IC card.

According to this exemplary embodiment, the user must be authenticated with respect to a specific multi-function device (e.g. MFD A or MFD B), in order for the relay apparatus to permit the user instruction to be transmitted to the specific multi-function device in accordance with the various aspects described throughout this disclosure. For example, the user authentication part may store an access control list (ACL) indicating which users are permitted to use each of the different multi-function devices (e.g. MFD A or MFD B). The processing part 20c only converts the user instruction into the format native to the selected multi-function device, and/or the device connector part 20d only transmits information to the selected multi-function device, if the user authentication part 20e determines that the user is authenticated to access the functionalities of the selected multi-function device.

According to this exemplary embodiment, the user must also be authenticated with respect to a specific server device (e.g. server A or server B), in order for the relay apparatus to access the functionalities of the specific server device in accordance with the various aspects described throughout this disclosure. For example, the user authentication part may store an access control list (ACL) indicating which users are permitted to use each of the different server device (e.g. server A or server B). The processing part 20c only converts the data into the format native to the selected server device, and/or the server connector part 20a only transmits information to the specific server device, if the user authentication part determines that the user is authenticated to access the specific server device.

Moreover, by authenticating the user of the relay apparatus, the authentication part 20e also permits various information to be collected with respect to the logged in user. For example, cost or accounting data can be collected and accumulated for the logged in user, based on the various scan or print jobs that may be performed by the logged in user. Such information can automatically be provided to accounting, billing or reimbursement departments, for example.

The aforementioned specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

What is claimed is:

1. An apparatus configured for user access to functionalities of plural heterogeneous multi-function device and plural heterogeneous server devices, said apparatus comprising:
a common user interface part configured to receive a user selection of a specific one of the plural multi-function devices and a user instruction to access functionalities of the selected multi-function device;
a processing part configured to convert the user instruction received by the common user interface part into a format native to the selected multi-function device;
a device connector part configured for communication with each of the plural multi-function devices, and configured to transmit the converted instruction to, and receive data from, the selected multi-function device in said format native to the selected multi-function device, to access said functionalities of the selected multi-function device; and
a server connector part configured for communication with each of the plural server devices,
wherein the processing part determines, based on the user instruction, a specific server device from among the plural server devices, and converts (i) the data received through the device connector part in said format native to the selected multi-function device and (ii) the user instruction, into a format native to the specific server device, and
the processing part causes the converted data and instruction to be transmitted through the server connector part to the specific server device in said format native to the specific server device, to access the functionalities of the specific server device based on the user instruction.

2. The apparatus of claim 1, wherein in a case that the user instruction corresponds to a scan operation instruction, the processing part converts the scan operation instruction into the format native to the selected multi-function device,
the device connector part transmits the converted scan operation instruction to the selected multi-function device to cause the selected multi-function device to perform the scan operation, and receives scan image data from the selected multi-function device in the format native to the selected multi-function device,
the processing part converts (i) the scan image data received by the device connector part in said format native to the selected multi-function device and (ii) the user instruction, into a format native to the specific server device, and
the server connector part transmits the converted scan image data and the converted user instruction to the specific server device in said format native to the specific server device, to access the functionalities of the specific server device based on the user instruction.

3. The apparatus of claim 2, wherein the scan operation instruction includes an instruction to store the scan image data in a particular storage unit connected to the specific server device, and
the server connector part transmits the converted scan image data and scan operation instruction to the specific server device in said format native to the specific server device, to cause the specific server device store the scan image data in the particular storage unit.

4. The apparatus of claim 2, wherein the scan operation instruction includes an instruction to email the scan image data to a particular email address, and
the server connector part transmits the converted scan image data and scan operation instruction to the specific server device in said format native to the specific server device, to cause the specific server device to email the scan image data to the particular email address.

5. The apparatus of claim 1, wherein in a case that the user instruction corresponds to a print operation instruction, the processing part converts the print operation instruction into the format native to the selected multi-function device,
the device connector part transmits the converted print operation instruction to the selected multi-function device to cause the selected multi-function device to process the print operation instruction, and receives a data request from the selected multi-function device in the format native to the selected multi-function device,
the processing part converts (i) the data request received by the device connector part in said format native to the selected multi-function device and (ii) the user instruction, into the format native to the specific server device,
the server connector part transmits the data request and the converted user instruction to the specific server device in said format native to the specific server device, and receives document data from the specific server device based on the user instruction,
the processing part converts the document data into print data in the format native to the selected multi-function device, and
the device connector part transmits the print data to the selected multi-function device to cause the selected multi-function device to perform the print operation.

6. The apparatus of claim 1, wherein in a case that the user instruction corresponds to a print operation instruction, the processing part generates a print data request in the format native to the specific server device, based on the print operation instruction,
the server connector part transmits the print data request to the specific server device, and receives document data from the specific server device,
the processing part converts the document data into print data in the format native to the selected multi-function device, and converts the print operation instruction into the format native to the selected multi-function device,
the device connector part transmits the converted print data and print operation instruction to the selected multi-function device, to cause the selected multi-function device to perform the print operation.

7. The apparatus of claim 1, further comprising an authentication part configured to authenticate the user of the relay apparatus,
wherein the processing part only converts the user instruction into the format native to the selected multi-function device, in a case that the user authentication part determines that the user is authenticated to access the functionalities of the selected multi-function device.

8. The apparatus of claim 1, further comprising an authentication part configured to authenticate the user of the relay apparatus,
wherein the processing part only converts the user instruction into the format native to the server device, in a case that the user authentication part determines that the user is authenticated to access the specific server device.

9. A system comprising:
plural heterogeneous multi-function devices;
plural heterogeneous server devices; and
an apparatus configured for user access to functionalities of the plural heterogeneous multi-function devices and the plural heterogeneous server devices, said apparatus comprising:
a common user interface part configured to receive a user selection of a specific one of the plural multi-function devices and a user instruction to access functionalities of the selected multi-function device;
a processing part configured to convert the user instruction received by the common user interface part into a format native to the selected multi-function device;
a device connector part configured for communication with each of the plural multi-function devices, and configured to transmit the converted instruction to, and receive data from, the selected multi-function device in said format native to the selected multi-function device, to access said functionalities of the selected multi-function device; and
a server connector part configured for communication with each of the plural server devices,
wherein the processing part determines, based on the user instruction, a specific server device from among the plural server devices, and converts (i) the data received through the device connector part in said format native to the selected multi-function device and (ii) the user instruction, into a format native to the specific server device, and
the processing part causes the converted data and instruction to be transmitted through the server connector part to the specific server device in said format native to the specific server device, to access the functionalities of the specific server device based on the user instruction.

10. The system of claim 9, wherein in a case that the user instruction corresponds to a scan operation instruction, the processing part converts the scan operation instruction into the format native to the selected multi-function device,
the device connector part transmits the converted scan operation instruction to the selected multi-function device to cause the selected multi-function device to perform the scan operation, and receives scan image data from the selected multi-function device in the format native to the selected multi-function device,
the processing part converts (i) the scan image data received by the device connector part in said format native to the selected multi-function device and (ii) the user instruction, into a format native to the specific server device, and
the server connector part transmits the converted scan image data and the converted user instruction to the specific server device in said format native to the specific server device, to access the functionalities of the specific server device based on the user instruction.

11. The system of claim 10, wherein the scan operation instruction includes an instruction to store the scan image data in a particular storage unit connected to the specific server device, and
the server connector part transmits the converted scan image data and scan operation instruction to the specific server device in said format native to the specific server device, to cause the specific server device store the scan image data in the particular storage unit.

12. The system of claim 10, wherein the scan operation instruction includes an instruction to email the scan image data to a particular email address, and
the server connector part transmits the converted scan image data and scan operation instruction to the specific server device in said format native to the specific server device, to cause the specific server device to email the scan image data to the particular email address.

13. The system of claim 9, wherein in a case that the user instruction corresponds to a print operation instruction, the processing part converts the print operation instruction into the format native to the selected multi-function device,
the device connector part transmits the converted print operation instruction to the selected multi-function device to cause the selected multi-function device to process the print operation instruction, and receives a data request from the selected multi-function device in the format native to the selected multi-function device,
the processing part converts (i) the data request received by the device connector part in said format native to the selected multi-function device and (ii) the user instruction, into the format native to the specific server device,
the server connector part transmits the data request and the converted user instruction to the specific server device in said format native to the specific server device, and receives document data from the specific server device based on the user instruction,
the processing part converts the document data into print data in the format native to the selected multi-function device, and
the device connector part transmits the print data to the selected multi-function device to cause the selected multi-function device to perform the print operation.

14. The system of claim 9, wherein in a case that the user instruction corresponds to a print operation instruction, the processing part generates a print data request in the format native to the specific server device, based on the print operation instruction,
the server connector part transmits the print data request to the specific server device, and receives document data from the specific server device,
the processing part converts the document data into print data in the format native to the selected multi-function device, and converts the print operation instruction into the format native to the selected multi-function device,
the device connector part transmits the converted print data and print operation instruction to the selected multi-function device, to cause the selected multi-function device to perform the print operation.

15. A method for user access to functionalities of plural heterogeneous multi-function devices and plural heterogeneous server devices by an apparatus, said method comprising:
receiving, by a common user interface part of the apparatus, a user selection of a specific one of the plural multi-function devices and a user instruction to access functionalities of the selected multi-function device;
converting, by a processing part of the apparatus, the user instruction received by the common user interface part into a format native to the selected multi-function device;
transmitting, by a device connector part of the apparatus configured for communication with each of the plural multi-function devices, the converted instruction to the selected multi-function device in said format native to the selected multi-function device, to access said functionalities of the selected multi-function device;
determining by the processing part, based on the user instruction, a specific server device from among the plural server devices, and converting (i) the data received through the device connector part in said format native to the selected multi-function device and (ii) the user instruction, into a format native to the specific server device; and
transmitting, through a server connector part of the relay apparatus configured for communication with each of the plural server devices, the converted data and instruction to the specific server device in said format native to the specific server device, to access the functionalities of the specific server device based on the user instruction.

16. The method of claim 15, further comprising:
determining, by the processing part, that the user instruction corresponds to a scan operation instruction, and converting the scan operation instruction into the format native to the selected multi-function device,
transmitting, by the device connector part, the converted scan operation instruction to the selected multi-function device to cause the selected multi-function device to perform the scan operation, and receiving scan image data from the selected multi-function device in the format native to the selected multi-function device,
converting, by the processing part, (i) the scan image data received by the device connector part in said format native to the selected multi-function device and (ii) the user instruction, into a format native to the specific server device, and
transmitting, by the server connector part, the converted scan image data and the converted user instruction to the specific server device in said format native to the specific server device, to access the functionalities of the specific server device based on the user instruction.

17. The method of claim 16, wherein the scan operation instruction includes an instruction to store the scan image data in a particular storage unit connected to the specific server device, and
the server connector part transmits the converted scan image data and scan operation instruction to the specific server device in said format native to the specific server device, to cause the specific server device store the scan image data in the particular storage unit.

18. The method of claim 16, wherein the scan operation instruction includes an instruction to email the scan image data to a particular email address, and
the server connector part transmits the converted scan image data and scan operation instruction to the specific server device in said format native to the specific server device, to cause the specific server device to email the scan image data to the particular email address.

19. The method of claim 15, further comprising:
determining, by the processing part, that the user instruction corresponds to a print operation instruction, and converting the print operation instruction into the format native to the selected multi-function device,
transmitting, by the device connector part, the converted print operation instruction to the selected multi-function device to cause the selected multi-function device to process the print operation instruction, and receiving a data request from the selected multi-function device in the format native to the selected multi-function device,
converting, by the processing part, (i) the data request received by the device connector part in said format native to the selected multi-function device and (ii) the user instruction, into the format native to the specific server device,
transmitting, by the server connector part, the data request and the converted user instruction to the specific server device in said format native to the specific server device, and receiving document data from the specific server device based on the user instruction,
converting, by the processing part, the document data into print data in the format native to the selected multi-function device, and
transmitting, by the device connector part, the print data to the selected multi-function device to cause the selected multi-function device to perform the print operation.

20. The method of claim 15, further comprising:
determining, by the processing part, that the user instruction corresponds to a print operation instruction, and generating a print data request in the format native to the specific server device, based on the print operation instruction,
transmitting, by the server connector part, the print data request to the specific server device, and receiving document data from the specific server device,
converting, by the processing part, the document data into print data in the format native to the selected multi-function device, and converting the print operation instruction into the format native to the selected multi-function device, and
transmitting, by the device connector part, the converted print data and print operation instruction to the selected multi-function device, to cause the selected multi-function device to perform the print operation.
